(19) United States
(12) Patent Application Publication
(10) Pub. No.: US 2003/0120793 A1
(43) Pub. Date: Jun. 26, 2003

(54) Method and arrangement for sending a video presentation

(76) Inventor: Pekka Marjola, Helsinki (FI)

Correspondence Address: SALTAMAR INNOVATIONS, 30 FERN LANE, SOUTH PORTLAND, ME, 04106, US

(21) Appl. No.: 10/041,021

(22) Filed: Jan. 7, 2002

(30) Foreign Application Priority Data
Dec. 21, 2001 (FI) 20012558

(51) Int. Cl. G06F 15/16

(52) U.S. Cl. 709/231

(57) ABSTRACT

This invention relates to sending video and voice or other continuous data over a network, such as the Internet, to subscribers' terminals. The invention uses a standard web server supporting an HTTP protocol, which is adapted to send consecutive video files to subscribers' terminals directly, or via a proxy. The server receives the encoded video data arranged into consecutive packets from a video provider's encoding element. The subscriber's terminal sends a request for the video desired to the web server or the proxy. As a response, the terminal receives the index file that contains the information of the current video file. When the subscriber's terminal knows the current video file, it can request the web browser to send, the first file. The subscriber's terminal can directly request the following files belonging to the video presentation.

### FIELD OF THE INVENTION

This invention relates to sending video and voice or other continuous data over a network, such as the Internet, to subscribers' terminals. Especially the invention concerns sending live video show from a video producer to subscribers.

### BACKGROUND OF THE INVENTION

There exist several solutions for sending real-time, i.e. live, video from a video producer to a customer's terminal. The RTP (Real-time Transport Protocol) and RTSP (Real Time Streaming Protocol) are usually the most common solutions used but other solutions exist as well.

RTP (Real-time Transport Protocol) provides end-to-end network transport functions suitable for applications transmitting real-time data, such as audio, video or simulation data, over multicast or unicast network services. RTP does not address resource reservation and does not guarantee quality-of-service for real-time services. Sequence numbers included in RTP allow the receiver to reconstruct the sender's packet sequence. The sequence numbers might also be used to determine the proper location of a packet, for example in video decoding, without necessarily decoding packets in sequence.

The RTP data transport is augmented by a control protocol (RTCP) to allow monitoring of the data delivery in a manner scalable to large multicast networks, and to provide minimal control and identification functionality. RTCP is based on the periodic transmission of control packets to all participants in the session, using the same distribution mechanism as the data packets. The underlying protocol must provide multiplexing of the data and control packets, for example using separate port numbers with UDP. RTCP provides feedback on the quality of the data distribution and carries a persistent transport-level identifier for an RTP.

Both RTP and RTCP are designed to be independent of the underlying transport and network layers.

The Real Time Streaming Protocol (RTSP) is an application-level protocol for control over the delivery of data with real-time properties. RTSP provides an extensible framework to enable controlled, on-demand delivery of real-time data, such as audio and video. Sources of data can include both live data feeds and stored clips. This protocol is intended to control multiple data delivery sessions, provide a means for choosing delivery channels such as UDP, multicast UDP and TCP, and provide a means for choosing delivery mechanisms based upon RTP

RTSP establishes and controls either a single or several time-synchronized streams of continuous media (audio and video i.e. data where a timing relationship exists between a sender and receiver). It does not typically deliver the continuous streams itself, although interleaving of the continuous media stream with the control stream is possible. In other words, RTSP acts as a remote control for multimedia servers. The set of streams to be controlled is defined by a presentation description. The stream means a single media instance, such as an audio stream or a video stream. When using RTP, a stream consists of all RTP and RTCP packets created by a sender within an RTP session.

An RTSP session is not tied to a transport-level connection such as a TCP connection. During an RTSP session, an RTSP client may open and close many reliable transport connections to the server to issue RTSP requests. Alternatively, it may use a connectionless transport protocol such as UDP. The streams controlled by RTSP may use RTP, but the operation of RTSP does not depend on the transport mechanism used to carry continuous media.

Since not all media servers have the same functionality, media servers by necessity will support different sets of requests. For example, a server is only capable of playback, or a server is not capable of seeking absolute positioning, if it is to support live events only, or furthermore some servers do not support setting stream parameters and thus not support GET parameter and SET parameter.

For compensating the lack of supporting various requests, RTSP can be extended in some ways. For example, existing methods can be extended with new parameters, as long as these parameters can safely be ignored by the recipient. Another way is to add new methods. If the recipient of the message does not understand the request, it responds with an error code and the sender should not attempt to use this method again. A client may also use the OPTIONS method to inquire about methods supported by the server. The server SHOULD list the methods it supports using the Public response header. Further, a new version of the protocol can be defined, allowing almost all aspects to change.

As can be noted, the known solutions for delivering live media streams are relatively complex. Furthermore, they are usually not supported in web servers in the Internet since they need special software. Many service providers have no interest to invest in different, expensive, and parallel media delivery systems. A primary goal of the invention is to alleviate the problems of the known solutions. This is achieved in a way described hereunder.

### SUMMARY OF THE INVENTION

An important concept of the invention utilizes a common web server (supporting an HTTP protocol), which is adapted to send consecutive video files to subscribers' terminals directly, or via a proxy. The server receives the encoded video data arranged into consecutive packets from a video provider's encoding element, called broadcaster. The sending from the broadcaster to the web server is preferably made using FTP (File Transfer Protocol) protocol. The FTP transport contains both the video data and index data. The index data identifies the current file that is being sent to the subscriber's terminal (preferably, the latest data file being sent to the web server). The subscriber's terminal sends a request for the desired video to the web server or the proxy. As a response, the terminal receives the index file that contains the information of the current video file (in addition, the invention can be used for any stream, not just video stream). When the subscriber's terminal knows the current video file, it can request the web browser to send, i.e. play, the current file becomes the first file for the particular client. Unless otherwise indicated or it is clear from context, in this application references to first file relate to the first file for a specific terminal as described above, i.e. a combination of general stream data and the current file in the presentation. The subscriber's terminal can directly request the following files belonging to the video presentation. A presentation means a set of one or more streams presented to the client as a complete media show. The transport between the web server and the subscriber's terminal is made using the HTTP protocol. Furthermore when using a standard HTTP proxy the requests for media files are identified in a way that the proxy can store them, and only a single connection from the proxy to the web server needs to be made for multiple viewers using the proxy.

Thus the preferred aspect of the invention comprises an arrangement for delivering at least one live presentation to at least one subscriber, via a network. Coupled to the network are at least one web server and at least one encoding element. The web server comprises a stream receiver module adapted to receiving continuous presentation data from the encoding element, a presentation arranger adapted to arrange the presentation data into a plurality of presentation files, said arranger also adapted to define a current presentation file. A delivery module is constructed to deliver the presentation files, starting from the current presentation file, responsively to client requests from subscribers.

Another aspect of the inventive arrangement comprises a player module in the subscriber terminal for playing the presentation and requesting the presentation files in a way that after receiving the index file the player module requests the first file of the presentation, the request containing the name of the presentation and an identification path information of the current file. Subsequent presentation files after the first file are deduced by the player module. The player module requests the subsequent files from the web server, and the request path info contains the name of the presentation and identification path information of the latest file for the presentation.

Yet further, the arrangement may comprise a proxy through which the presentation files are delivered from the web server to the subscriber terminal, the proxy being capable to save the presentation files.

The invention also concerns the method comprising the steps of: receiving a continuous media stream and identifying information of a current presentation data in real-time in a web server; forming presentation files from the continuous media stream and saving real-time identifying information; and delivering the presentation files responsively to a request for the live presentation in such a way that the identifying information identifies the first file to be delivered, and subsequent requests identify directly the following presentation files to be delivered.

In a preferred aspect of the delivering step of the presentation files is performed in such a way that the continuous presentation data which is arranged into the file is sent to the subscriber terminal in real-time before the whole file is formed.

It is also desired the method further comprise the steps of: forming in real-time a continuous media stream; and identifying frequently a current presentation data in the media stream, more preferably prior to the step of receiving.

The requests are preferably HTTP requests comprising path info of the presentation files. Depending on the path info of the request a single presentation file or a group of presentation files are delivered as a response to the request. The presentation files may be delivered through a proxy, which is capable to buffer, i.e. save the presentation files. The proxy can preferably multicast the live presentation utilizing the saved files.

### BRIEF DESCRIPTION OF THE DRAWINGS

In the following the invention is described in more detail by means of FIGS. 1-4 in the attached drawings where

FIG. 1 illustrates an example of the arrangement according to the preferred embodiment of the invention,

FIG. 2 illustrates an example of the data and index packets delivered from the broadcaster to the web server,

FIG. 3 illustrates an example of a media stream send to a subscriber, and

FIG. 4 illustrates an example of a flow chart describing the method according to the preferred embodiment of the invention.

FIG. 5 depicts an internal construction of a web server in accordance with a preferred implementation of the invention.

### DETAILED DESCRIPTION

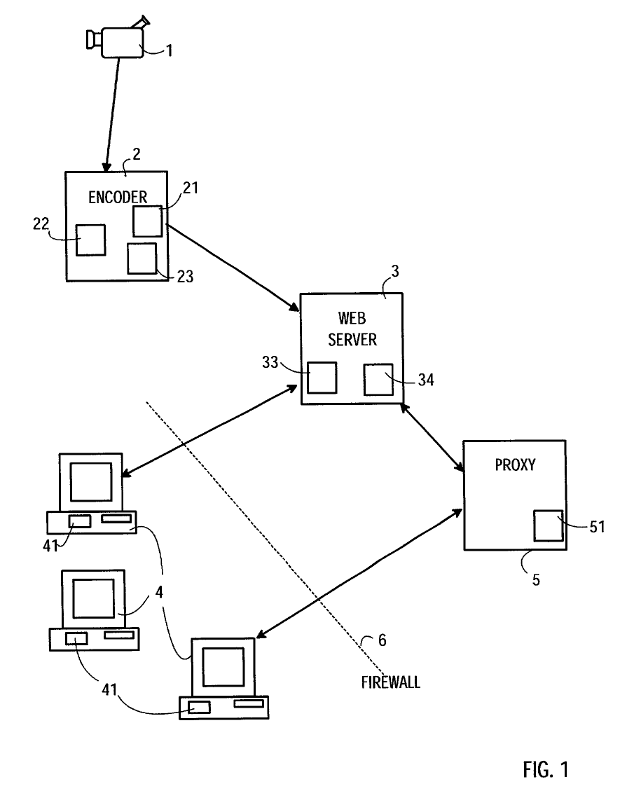

FIG. 1 shows a preferred embodiment of an arrangement according to the invention. Let a video provider be at a popular festival for making a live show for distributing the festival to subscribers. A camera 1 is connected to an encoding element 2, called a broadcaster. The broadcaster contains means 21 for receiving information from video and audio devices, such as the cameraman's camera, used to capture video information. The broadcaster supports different formats of video and audio, for example, DV, analog, or other formats. It is also possible to define frame rate for the video to be captured. Audio and video are preferably synchronized.

The broadcaster encodes the captured video (and voice) using an encoding module 22. The video can, for example, be encoded to the MVQ (Motion Vector Quantization) format, but other suitable encoding methods can also be used. Since the encoding process is relatively tedious, and it is not convenient to send large video files via long transmission paths, the broadcaster is preferably situated near the origin of the video source.

The broadcaster contains means 23 for sending the encoded video (and voice also) to a web server 3. The broadcaster uses regular FTP connection to send the streaming data (usually simultaneous video and voice streams) to the server. Any convenient transmission protocol can also be utilized. The sending means 23 also contains connection options such as a destination address of the FTP server, e.g. the web server 3, bandwidth and an FTP port. The presentation originator selects a name of the data stream, and a directory with a name that is to be created on the web server. When first opening the FTP connection to the server, the broadcaster sends the web server an index file that describes the characteristics of the streams that are going to be sent over the FTP connection. The broadcaster sends the streaming data to the FTP server, i.e. the web server, which is identified by its IP addresses. The data are transmitted as soon as they are available (encoded and arranged into consecutive packets called fragments and segments) in the broadcaster.

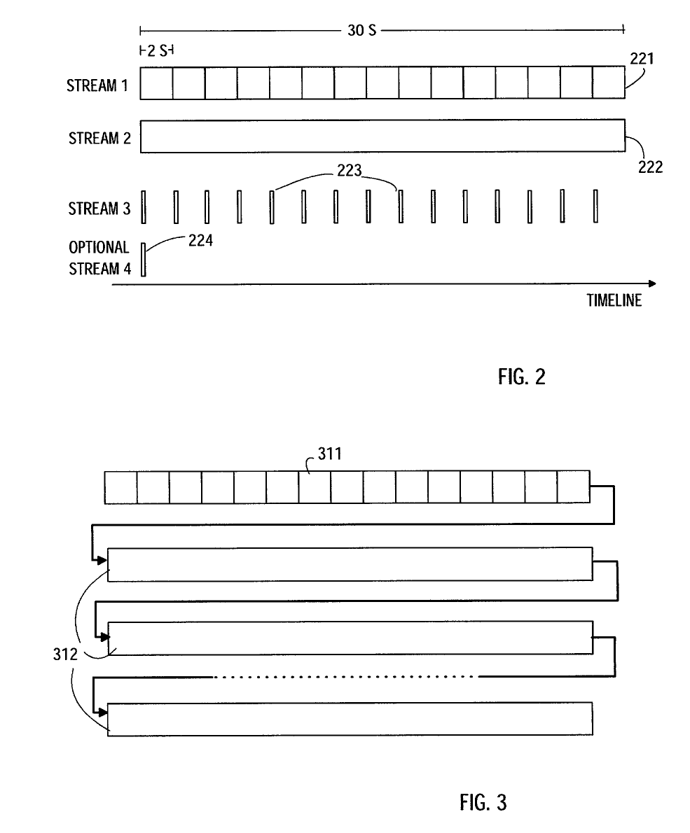

There are actually two separate data streams for each transmission from the broadcaster to the web server as described in FIG. 2. The first data stream 221 contains small fragments (preferably about 2 seconds of data), and the second data stream 222 larger segments (preferably about 30 second of data). The lengths of the fragments and segments are configurable features. The small fragments allow the subscriber to start watching the video presentation without a considerable delay, while the larger segments reduce the load on the web server when the clients switch to download larger segments instead of the fragments.

One segment contains 15 fragments (in this case). The fragments are named so that the first fragment of the whole continuous stream is called 1-1. mvq, the second 1-2. mvq and so on, until all the fragments that fit into one segment have been sent. After the segment is transmitted, the naming changes so that the change of the segment is indicated in the fragment name by increasing the first number of the name by one. So the first fragment in the second segment is named 2-1. mvq. Next one is 2-2. mvq and so on. The segments are also named sequentially so that the first segment in the continuous stream is called 1. mvq, the next 2. mvq, and so on. The naming of the fragments and segments makes it possible for the web server to deduce the current file and fragment in the segment.

The broadcaster starts to send both the fragments and the segments as soon as it has established an FTP connection with the web server and there exists valid encoded data to be sent. The Streams (consecutive transport packets containing data files) are sent to the server in the pre-chosen location and all the files are preferably saved into the same directory 34.

As showed in FIG. 2, index files 223 (forming the third stream) are also sent to the web server. The index files are frequently sent at the beginning of each fragment file. The index file tells the web server the required information about the data files that the broadcaster is sending over the FTP connection. It should be noted that the index file may be transported over any convenient connection, not necessarily the FTP connection. The index file is named index.idx, and the first index file is initially sent to the server when the session, for example broadcasting, starts. The web server caches only the latest index file and is updated after either new fragment or segment is written to the server. The index file is overwritten each time a new fragment starts. For a video show request from the clients, the web server always reads the current data in the index file.

More specifically, the index file tells also what is the current segment and fragment number, and also the size (in bytes) of the fragments and the segments. Due to this the index file keep an order of the encoded data in the form of fragments and segments. Further, the index file tells how many fragments are included in each segment. This allows, for example, the player in the subscriber's terminal 41 to know when to switch from requesting the segments instead of the fragments. The web server then returns the requested item. However, the web server uses index file data to know when the last fragment is finished, since it has to search for the next file to appear before it knows that previous file has been finished. Alternatively, each data file may end with known byte-sequence so that appearance of next file need not be known. As mentioned, the index file is constantly refreshed at the web server as new fragments and segments are written to the server.

The index file is located in the same directory wherein the data of the steams is stored. The index data has the following format:

Frag=num

Numfrag=num

Fragsize=num

Seg=num

Segsize=num

Frag specifies the current fragment number. Numfrag specifies the number of fragments in each segment. Fragsize specifies the size of the fragment in bytes. Seg specifies the current segment number. Segsize specifies the size of the segment in bytes. The colon indicates the end of the index file. The colon is important, since index file is updated constantly, and web server might reach end-of-file before the new file had been fully written.

The web server 3 is adapted to handle continuous media stream. The adaptation is achieved using a special CGI (Common Gateway Interface) program or server extension 33 (server extension such as Java Servlets, Apache modules, ASP) The CGI program accepts requests from subscribers for video show (streaming data from the broadcaster which is saved in consecutive files in the web server). It reads the data files as sent by the broadcaster, and transmits the files to the subscribers. The sending of the presentation files is performed in such a way that the continuous presentation data, which is arranged into the file, is sent to the subscriber terminal in real-time before the whole presentation (file) is formed. For determining the current files CGI checks the status of the index file, which indicates the current file. The information of the index is sent to the subscriber's terminal after which the terminal can directly request the current and subsequent data files. The subsequent data files can be deduced by the naming system of the fragments and segments. The index file is dynamically updated and is read each time when the CGI program is called.

In other words, data stream is sent to the subscribers 4 in small fragments starting from the file specified by the index. Small fragment size reduces the starting delay. Every client starts at the beginning of the latest fragment, so that worst case delay is of one fragment size, at the server file delivery point. Since there are other factors causing delay, such as encoding, transport and buffering, a few second delay caused by fragment size is acceptable. Later, larger segments are sent to reduce a number of HTTP requests. Using files to represent parts of broadcast allows requests for older data, and easy deletion of specified older parts of broadcasts. In addition, proxies can cache each part separately. Separate requests also make the system compatible with HTTP 1.0, since accessing parts of the files requires HTTP 1.1.

Optionally, the broadcaster generates an additional index file (FIG. 2, 224) for each segment to prepare video data for watching after live show. The segment index file is named x.idx. where x indicates the segment number. The segment index file tells the server the number of the segment for which and the size of the segment in bytes. The segment index file has the following format:

Seg=num

Segsize=num

Seg specifies the number of the segment this index file is for. Segsize specifies the size of the segment in bytes. The colon indicates the end of the index file.

Data files are sent based on a request from a subscriber. The CGI program reads the file indicated by parameters, and reads the data file as it is written to the server directory. When reaching the first request for getting a video representation the CGI program must read the index file send by the broadcaster. After this CGI gets direct requests for the latest video representation file. The CGI program accepts following parameters using HTTP GET method to allow caching: GET query parameters are not used. Instead, PATH_INFO is used in the following format:

http://server/oplayo/live/video/videoname/seg/num/frag/num Using query parameters would cause many proxies to consider the request a dynamic request, preventing caching. Using path_info turns parameters to look like directories and files, so proxies cache the response, and request only single copy of data for simultaneous connections through the same proxy. This increases the capacity of the system.

VIDEO=videoname

SEG=num

FRAG=num

VIDEO specifies the video to be sent. If no additional data is specified, the index data is sent to the subscriber. SEG specifies the current segment. This requires that the video has been specified. The segment number is sent back to the subscriber. FRAG specifies the current fragment. This requires that the video and segment have been specified. The fragment number of the segment is sent back to the subscriber.

Even thought, using the CGI program means that a new process must be started for each request coming from the subscribers, the load and delay should be marginal. Further, since no server specific extension is used (only a server supporting a normal HTTP is required), the solution is not fixed to a single web server. Server extension can be used to improve performance. An important aspect of the invention is that data files are read as they are written in the FTP upload directory, and that all data can be cached in proxies.

Instead of delivering a continuous data stream directly to a subscriber, the data stream can be deliver via a proxy 5 or a CDN (Content Delivery Network) A CDN is a service offered by a service provider. Fundamentally, a CDN maintains multiple locations with copies of the same content, and uses information about the user and the content requested to “route” the user to the most appropriate site. The proxy or CDN contains directory means 51 for saving media stream files.

FIG. 3 shows an example of a continuous media stream, which is delivered to a subscriber. Since the media stream is a live stream, a moment when the CGI program in the web server defines the current file to be delivered first is unknown. Let the moment represent fragment 7 311 in a segment. CGI delivers fragments 7 to 15 to the subscriber before it changes to deliver segments 312.

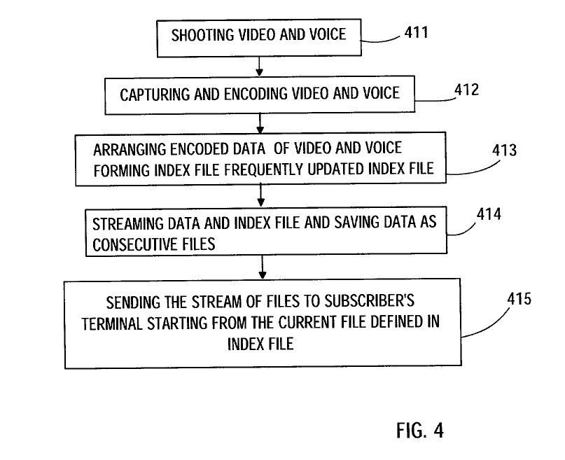

FIG. 4 illustrates the method according to a preferred embodiment of the invention. First, material for a video (and voice for it) must be taken 411. When shooting the clips, the video and voice is captured by the broadcaster, which encodes the captured material 412. The encoded video and voice is arranged into consecutive packets 413, and an index file is formed to represent the organized data. The index file contains information of the current packet. The index file is updated frequently.

The consecutive data are streamed to the web server 414. This means that the connection between the broadcaster and the web server is established and the data are situated into transmission packets. The format of transmission packets depends of the transmission protocols used. Now the web server comprises the live stream of video show from where a subscriber may request it whenever desired.

When the subscriber requires the video show, CGI sends 415 the current index file as a response to the subscriber. After this the subscriber's terminal can directly request the current file from the web server where CGI defines the current file in the stream to be delivered to the subscriber.

In the subscriber's terminal 4, an applet or another means for requiring, receiving and playing video shows 41 downloads the data files based on the requests. The applet, called player, requires frequently the latest video show file. The first file is obtained using the index file. Subsequent files are achieved with direct requests concerning the files. The consecutive video files form a continuous data stream. Due to unexpected situations the player preferably buffers the data for a moment before playing.

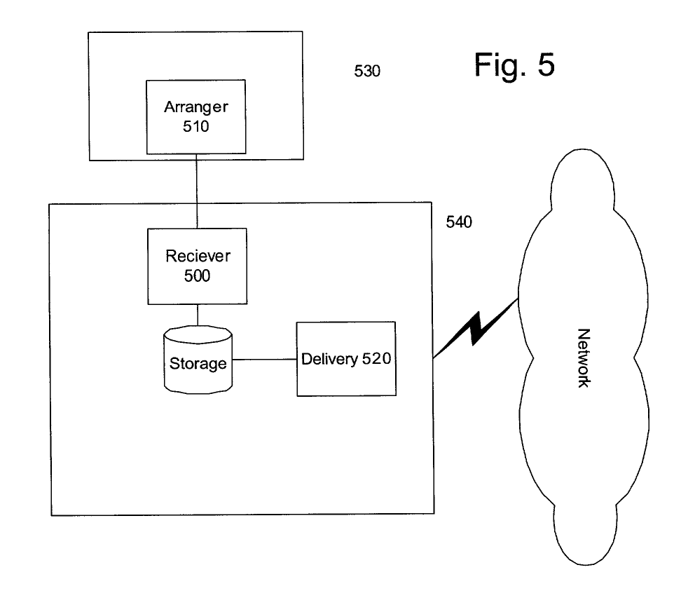

FIG. 5 depicts an internal construction of a web server in accordance with a preferred implementation of the invention. Stream receiver module 500 is adapted to receive continuous presentation data from the broadcaster encoding element. The presentation arranger 510 arranges the presentation data into a plurality of presentation files. The arranger also defines the current presentation file, which is the first presentation file to be delivered to a new client request.

A delivery module 520 delivers the presentation files, starting from the current presentation file, in response to requests from a subscriber.

For illustration purposes, FIG. 5 depicts a distributed web server, i.e. a web server where the functionality of the server resides in more than one computer. However it will be clear that the invention extends to implementations using a single computer. It should also be noted that as in the FIG. 5 example, the broadcaster is a part of the distributed web server, and resides with the arranger on a first computer 530, while the receiver module and the delivery module are executed on a second computer 540.

The different functional modules may be within a single computer, or may be spread across several computers. Similarly, portions of the functionality of the modules themselves may be distributed, e.g. the arranger may have a portion designating the current file may reside on a broadcaster computer, while the actual separation into presentation files resides in a separate web server computer.

As mentioned, in the preferred embodiment 2 second files are downloaded before the following 30 second file starts. Longer files mean less requests and smoother functionality. Data files are asynchronously downloaded (independent of playing data), so that there are no stops. Small files are easier to handle in the cache than large files. And several subscribers who request the same video may actually get the same small file from the proxy. The CGI program follows the frag number in the index file, and when it tells that the current segment is full, CGI knows that the next segment starts. This information can be used when the web server is switched (The applet comprises a switching module for requesting segments or fragments.) to send segments instead of fragments.

Although above, there are described that the fragment and segment streams are needed for smooth function of the arrangement, alternatively only the fragment stream is required. The CGI program and the player can be adapted to handle fragments as virtual segments. This can be achieved by utilizing the naming system of the fragments. After receiving the index file and first fragments the player can send requests only at the beginning of each virtual segment. The CGI program understands to send all fragments belonging to the virtual segment as a response to the requests.

The invention makes is possible to use common web servers that support an HTTP protocol. No separate streaming servers are required. No special components are needed in a proxy (or in CDN). Furthermore, the player may be switched to downloading small files, if the download speed is too low.

In the broadcaster, It is also possible to save live streams and play them at a later time. The name of the save file is specified before starting the broadcast. The saving function may be turned off or on during the broadcast transmission or the saving can be automatic. It may also be possible to construct a stream that contains only video or audio. An audio codec can be selected. Furthermore, the video input can be filtered before encoding. The filter reduces the noise that is in the picture information and thus smoothes the picture.

Since the invention utilizes a standard HTTP protocol, firewalls (FIG. 1, 6) are not a problem for receiving a live video show. Most firewalls probably let HTTP messages go through. In addition, many firewalls have timeouts for long transmissions. Since the invention uses separate requests, there is no problem with long transactions, though a use of persistent HTTP connection reduces delays.

It is also possible to use a number of segments of different sizes in a way that fragments fill the smallest segments, the smallest segments fill the next smallest segments and so on until the largest segments are filled.

As can be noted from the variety of the mentioned examples, the invention is not restricted to those described in this text, but the invention can be used in other solutions as well, in the scope of the inventive idea.

What is claimed is:

1. An arrangement for delivering at least one live presentation to at least one subscriber, via a network having at least one web server and at least one encoding element connected thereto, the arrangement comprises
a stream receiver module adapted to receiving continuous presentation data from the encoding element;
a presentation arranger adapted to arrange the presentation data into a plurality of presentation files, said arranger also adapted to define a current presentation file;
a delivery module is constructed to deliver the presentation files, starting from the current presentation file, responsively to requests from a subscriber.

2. An arrangement according to claim 1, wherein said delivery module is adapted to begin delivery of the content of a presentation file prior to completion of forming of said file.

3. An arrangement according to claim 2, characterized in that an index, which is updated frequently, containing information of the current presentation file is used for defining the first presentation file for the delivering to the subscriber.

4. An arrangement according to claim 3, characterized in that the index is an index file.

5. An arrangement according to claim 4, characterized in that the index file is created in the encoding element, and sent frequently to the web server.

6. An arrangement according to claim 1, characterized in that at least one of said requests is an HTTP GET method containing path information pointing to the presentation.

7. An arrangement according to claim 6, characterized in that the path information contains the name of the presentation.

8. An arrangement according to claim 4, characterized in that after receiving the request the delivery module sends the index file as a response to the subscriber.

9. An arrangement according to claim 8, further comprising a player module in the subscriber terminal for playing the presentation and requesting the presentation files said player constructed to request the first file of the presentation based on initial information contained in said index file.

10. An arrangement according to claim 9, wherein said player is constructed to deduce the desired subsequent presentation files, including a request path information for the subsequent files, and request said subsequent files from said web server.

11. An arrangement according to claim 10, characterized in that said request path information contains fragment and segment information of the presentation file, the segment information indicating a part of the continuous data and the fragment information indicating a part of the segment information.

12. An arrangement according to claim 11, wherein said delivery module is adapted to deliver to a player module presentation files related to the segment information, if no fragment information is provided within a request from a player.

13. An arrangement according to claim 1, wherein at least a portion of said arranger resides on a first computer, and said stream receiver module and delivery module reside on a second computer

14. An arrangement according to claim 13, wherein said first computer comprises a broadcaster.

15. An arrangement according to claim 2, characterized in that the delivery module comprises a CGI program.

16. An arrangement according to claim 14, characterized in that the delivery module comprises a CGI program.

17. An arrangement according to claim 2, characterized in that the delivery module comprises a server extension.

18. An arrangement according to claim 14, characterized in that the delivery module comprises a server extension.

19. An arrangement according to claim 5, characterized in that the encoding element is constructed to create the index file and arrange the continuous data into entities defined in the index file.

20. An arrangement according to claim 12, characterized in that the player is constructed to switch between requesting fragments to requesting segments.

20. An arrangement according to claim 16, characterized in that the player is constructed to switch between requesting fragments to requesting segments.

21. An arrangement according to claim 1, further comprising a proxy through which the presentation files are delivered from the web server to the subscriber, the proxy being capable to save the presentation files.

22. An arrangement according to claim 2, further comprising a proxy through which the presentation files are delivered from the web server to the subscriber terminal, the proxy being capable to save the presentation files.

23. An arrangement according to claim 20, further comprising a proxy through which the presentation files are delivered from the web server to the subscriber terminal, the proxy being capable to save the presentation files.

24. A method for delivering a live presentation to at least one subscriber via a network, the method comprising the steps of:
a) receiving a continuous media stream and identifying information of a current presentation data in real-time in a web server
b) forming presentation files from the continuous media stream and saving the real-time identifying information, and
c) responsive to a client request, utilizing the identifying information to select a first file
d) delivering said first file or a portion thereof to the client; and
e) delivering subsequent presentation files responsive to client subsequent requests identifying specific presentation files to be delivered.

25. A method according to claim 24, wherein said step of delivering the first file or the step of delivering subsequent files begin prior to completion of the file to be delivered.

26. A method according to claim 25, characterized in that prior step a) the method further comprises the steps of:
forming in real-time a continuous media stream, and
identifying frequently a current presentation data in the media stream.

27. A method according to claim 25, characterized in that the requests are HTTP requests comprising path information of the presentation files.

28. A method according to claim 27, wherein a plurality of presentation files are delivered to said client, according to said path information.

29. A method according to claim 25, characterized in that the delivering the presentation files is made through a proxy, which is capable of saving said presentation files.

30. A method according to claim 27, characterized in that the delivering the presentation files is made through a proxy, which is capable to save the presentation files.

31. A method according to claim 29, characterized in that the proxy multicasts the live presentation utilizing the saved files.

32. A method according to claim 30, characterized in that the proxy multicasts the live presentation utilizing the saved files.

33. A web server comprising:
a stream receiver module adapted to receive continuous presentation data from the encoding element;
a presentation arranger adapted to arrange the presentation data into a plurality of presentation files, said arranger also adapted to define a current presentation file;
a delivery module constructed to deliver the presentation files, starting from the current presentation file, responsively to requests from a subscriber.

34. The web server of claim 33, wherein the functionality of said server is distributed between a plurality of computers.

35. The web server of claim 33, wherein
said presentation arranger is constructed to create, and frequently update an index file, said index file containing information identifying a current presentation file.

36. The web server of claim 34, wherein
said presentation arranger is constructed to create, and frequently update an index file, said index file containing information identifying a current presentation file.

37. The web server of claim 33 wherein delivery module is adapted to deliver a presentation file or an index file prior to completion of such file.

38. The web server of claim 34 wherein delivery module is adapted to deliver a presentation file or an index file prior to completion of such file.

39. The web server of claim 33 wherein said presentation arranger is constructed to arrange a presentation file to contain fragments of a presentation.

40. The web server of claim 34 wherein said presentation arranger is constructed to arrange a presentation file to contain fragments of a presentation.

41. A computer readable media containing software that when executed by a computer causes said computer to substantially perform the method of claim 24.

42. A computer readable media containing software that when executed by a computer causes said computer to substantially perform as the web server of claim 33.
